(19) United States
(12) Patent Application Publication
(10) Pub. No.: US 2016/0361659 A1
(43) Pub. Date: Dec. 15, 2016

(54) METHOD AND SYSTEM FOR INSTANT MESSAGING AND GAMING

(71) Applicant: SPLENDOR GAME TECHNOLOGY CO., LTD., TAICHUNG CITY (TW)

(72) Inventors: KANG-WEI KU, TAICHUNG CITY (TW); SHUN-PIN LIN, TAICHUNG CITY (TW)

(21) Appl. No.: 14/863,903

(22) Filed: Sep. 24, 2015

(30) Foreign Application Priority Data
Jun. 12, 2015 (TW) 104119038

(51) Int. Cl. A63F 13/87

(52) U.S. Cl. CPC A63F 13/87

(57) ABSTRACT

An instant messaging and gaming method for use in an electronic device is disclosed to include the step of displaying on an interface a menu bar providing an instant messaging option and a game option and a content screen, the step of receiving an instruction of triggering the game option for enabling the content screen to provide a game content and a game status, and the step of receiving an instruction of triggering the instant messaging option for enabling the content screen to provide an instant messaging content and the game status. Thus, the user can get the latest game status from the content screen without switching the screen when performing an instant messaging.

### BACKGROUND OF THE INVENTION

### 1. Field of the Invention

The present invention relates to network gaming and instant messaging technology, and more particularly to method and system for instant messaging and gaming.

### 2. Description of the Related Art

With the increasingly popularity of mobile electronic devices and communication networks, various network online games have been developed vigorously. However, regular online games simply provide a screen for game operation. There are some online games allow the user or player to input an instant message in the game operating screen for interacting with other players, however, if the user is stopped from playing the online game, the user will be unable to continue instant messaging for communication with other players or friends. Further, the user cannot use instant messaging to communicate with friends who do not play this online game.

Further, if the user wishes to chat with friends in other online community software when playing the online game, the user often needs to leave the game, and then to turn to the online community software for chatting with friends, and the user will be unable to know the progress and status of the online game when chatting with friends in the online community software.

### SUMMARY OF THE INVENTION

The present invention has been accomplished under the circumstances in view. It is the main object of the present invention to provide an instant messaging and gaming method and system, which allows the user to select the desired online game, to use instant messaging for communication with other players or friends, and to be aware of the current progress of the online game synchronously during instant messaging.

To achieve this and other objects of the present invention, an instant messaging and gaming method for use in an electronic device comprises the step of displaying on an interface a menu bar providing an instant messaging option and a game option and a content screen, the step of receiving an instruction to trigger (click on) the game option for enabling the content screen to provide a game content and a game status, and the step of receiving an instruction to trigger (click on) the instant messaging option for enabling the content screen to provide an instant messaging content and the game status.

To achieve this and other objects of the present invention, an instant messaging and gaming system comprises a plurality of game servers respectively providing a game, at least one instant messaging server, a master server linked with the game server and the at least one instant messaging server, and at least one electronic device adapted for running a program to link to the master server and to display an interface comprising a menu bar and a content screen. The menu bar comprises an instant messaging option and a game option so configured that when the game option is triggered, the content screen provides a game content and a game status; when the instant messaging option is triggered, the content screen provides an instant messaging content and the game status.

Thus, when using instant messaging to communicate with other players or friends during the online game, the user can be aware of the game status and progress from the content screen without triggering the game option.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a system block diagram of an instant messaging and gaming system in accordance with the present invention.

FIG. 2 is a schematic drawing illustrating the arrangement of the display interface of the electronic device shown in FIG. 1.

FIGS. 3-7 illustrate different contents displayed on the display interface of the electronic device.

### DETAILED DESCRIPTION OF THE INVENTION

Prior to reading the following detailed description of the invention, it is to be understood that the component parts, sizes and appearance of the instant messaging and gaming system illustrated in the annexed drawings are simply for describing the technical features of the invention but not intended for use to limit the scope of the invention.

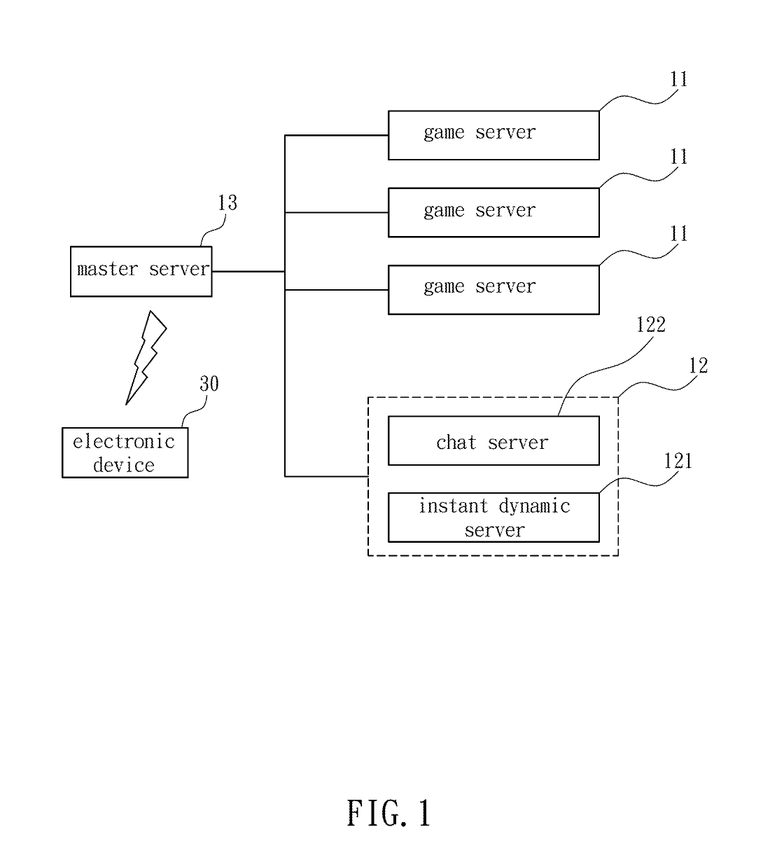

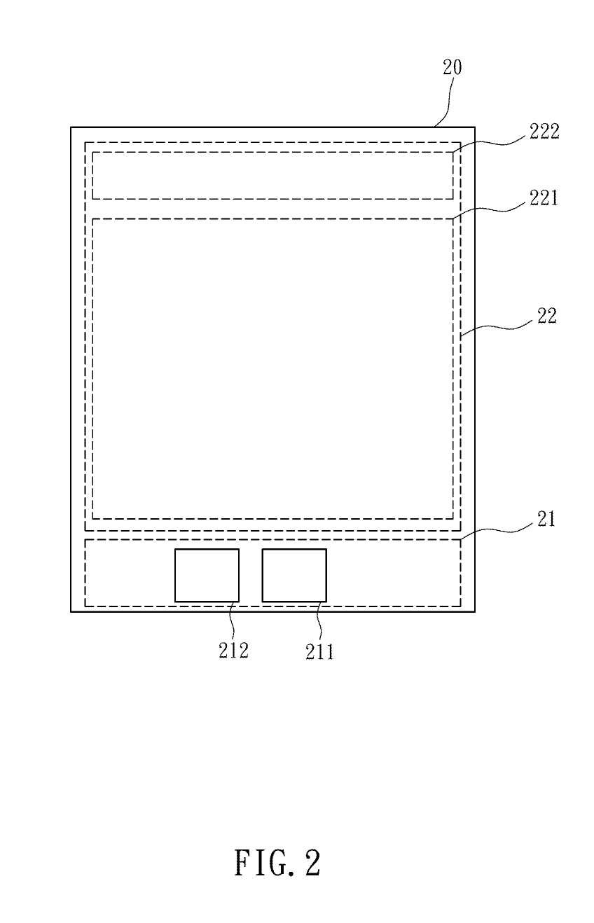

Referring to FIGS. 1 and 2, an instant messaging and gaming system 10 comprises a plurality of game servers 11, instant messaging server unit 12 and a master server 13. The game servers 11 respectively provide a game logic, such as the game of mahjong, roulette, baccarat, bingo or poker and other games. Every game server 11 runs the game logic. The master server 13 is linked with the game servers 11 and the instant messaging server unit 12, and provides a program.

The aforesaid program can be stored in a cloud, storage medium or app publishing platform. The cloud can be, for example, internet access and storage space, network website, etc. The storage medium can be, for example, hard disk drive, CD-ROM, flash drive, etc. The app publishing platform can be, for example, App store or Google Market.

In the present preferred embodiment, the instant messaging server unit 12 comprises an instant dynamic server 121 and a chat server 122.

The user can use an electronic device 30 (such as tablet computer, smart phone, or any other mobile electronic device) to download the program from the internet and to run the program so as to link to the master server 13. At this time, the electronic device 30 will display an interface 20. Further, the operating system of the electronic device 30 can be iOS, Android, Windows Phone, etc.

The interface 20 comprises a menu bar 21 and a content screen 22. The menu bar 21 comprises a game option (button) 211, and an instant messaging option 212.

In this embodiment, the content screen 22 comprises a main display area 221 and an auxiliary display area 222. The main display area 221 and the auxiliary display area 222 are adapted for displaying different contents.

After understanding the hardware composition and the display function of the electronic device, the operation of the instant messaging and gaming system is outlined hereinafter.

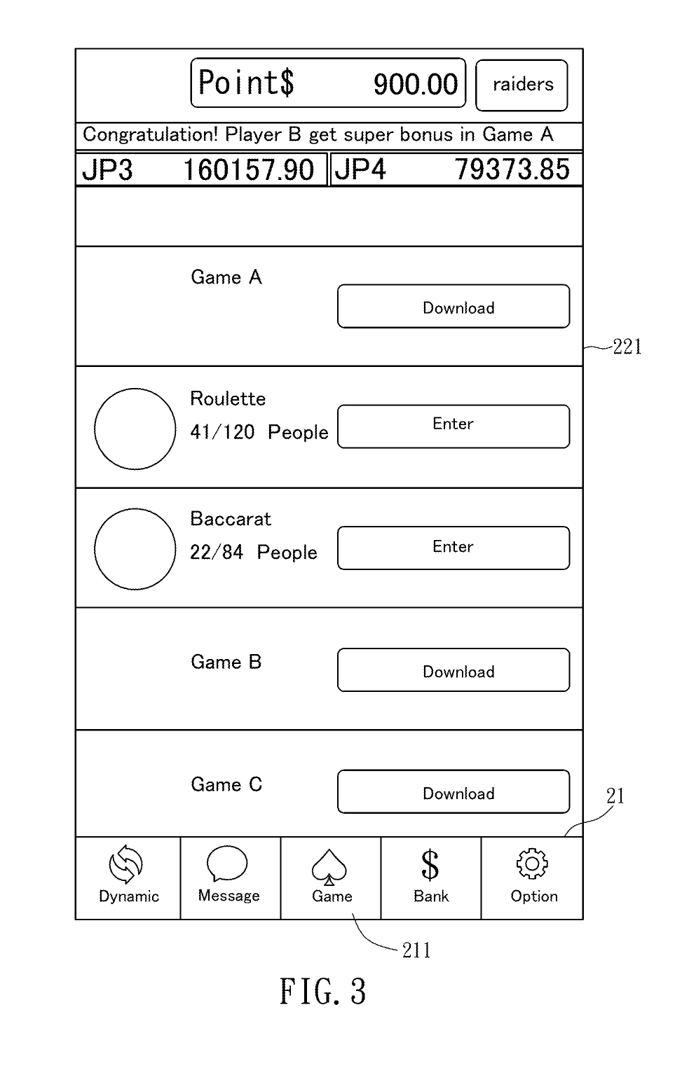

As shown in FIG. 3, when the user triggers (clicks on) the game option 211, the electronic device receives an instruction corresponding to the triggering of the game option 211 and then drives the main display area 221 of the content screen 22 to display multiple game items, such as video roulette shown in the drawing, video baccarat, mahjong story, etc. for allowing the user to select the desired game item. These game items are respectively corresponded to the game logics of the game servers 11 shown in FIG. 1.

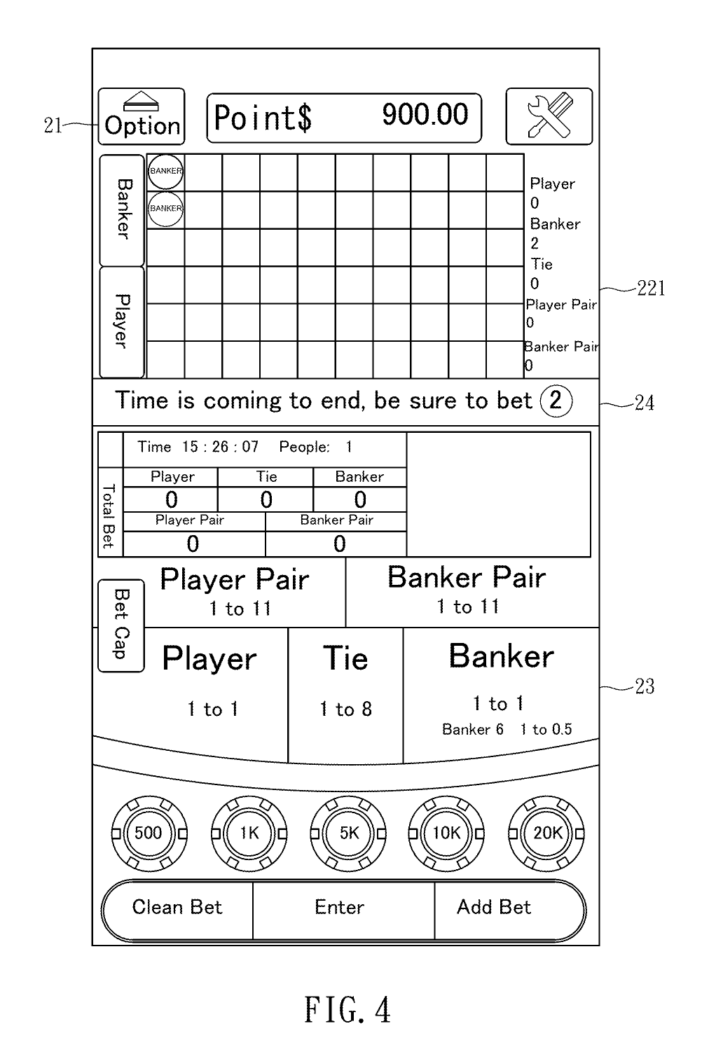

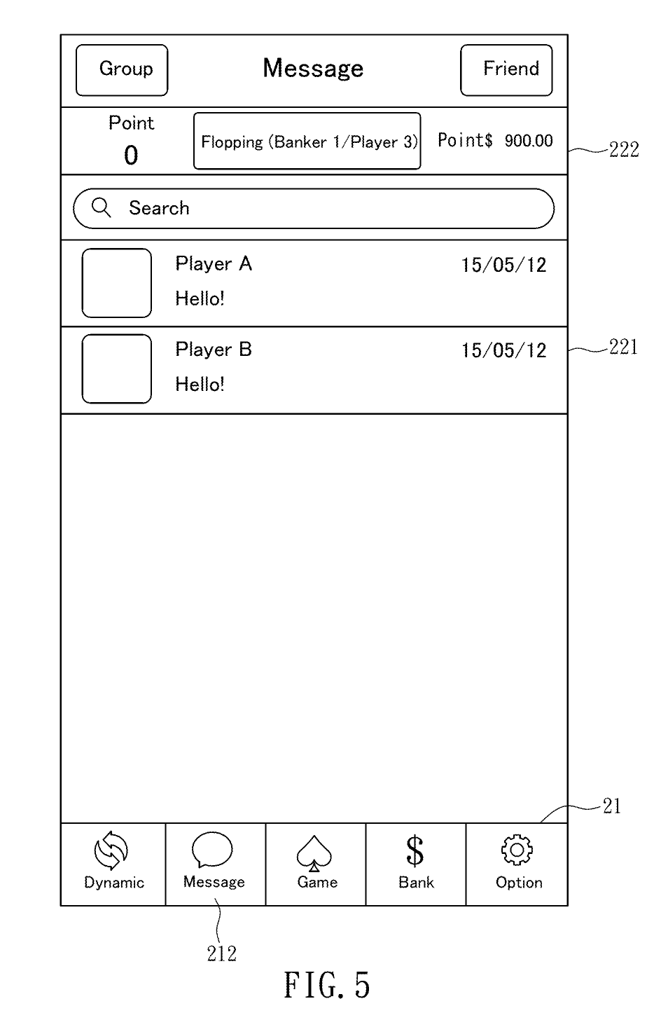

Thereafter, the user triggers (clicks on) one game item, for example, o roulette shown in the drawing, video baccarat, as shown in FIG. 4. At this time, the main display area 221 of the content screen 22 is switched to display a video baccarat game screen for enabling the user to play the online game according to a game content 23 in the main display area 221, and the auxiliary display area 222 of the content screen 22 is switched to display a game status 24, wherein the difference between FIG. 4 and FIG. 3 is that the position of the menu bar 21 in FIG. 4 is shifted to the upper left corner, and, the user can trigger (click on) the menu bar 21 to display out the options. During the operating process of the selected game, the main display area 221 displays a game result each time the game is over. The game result comprises a score and an accumulative score.

If the user triggers (clicks on) the menu bar 21 and selects the instant messaging option 212 during the online game, the electronic device receives an instruction of triggering the instant messaging option, and switches the main display area 221 of the content screen 22 to display an instant messaging content for allowing the user to select a chat partner for chatting.

Particularly, during the instant messaging session, the auxiliary display area 222 of the content screen 22 keeps displaying the game status, such as GAME START, CLOSING OF BETS, FLOP, COUNCIL SCORE, etc., thus, the user can trace the game status and progress during the instant messaging session without switching from an instant messaging screen to a game screen.

It is to be noted that, the action that the user triggers (clicks on) the menu bar 21, the game item, the game option 211 and the instant messaging option 212 is that the user operates the keyboard, buttons or touchscreen of the electronic to drive the electronic device to generate a corresponding instruction for controlling the switching of the interface.

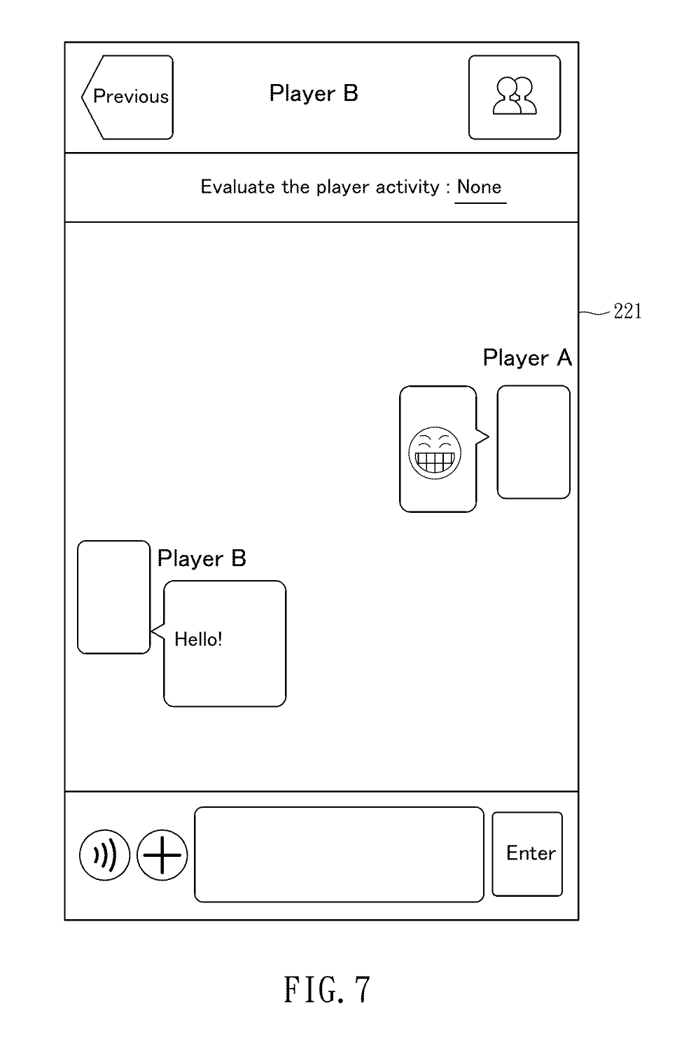

As illustrated in FIG. 7, the user can select any player and chat with the selected player. Similarly, other players can transmit messages to the user.

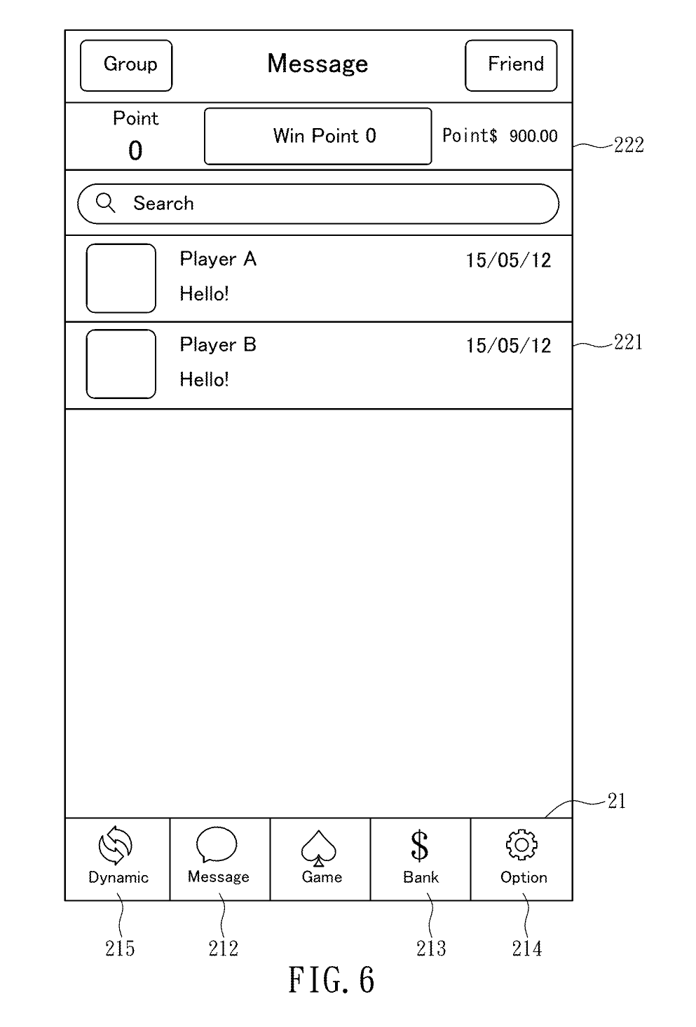

Referring to FIG. 6 again, the menu bar 21 further comprises a game cash flow option 213, a personal setup option 214, and an instant dynamic option 215. The user can trigger (click on) the game cash flow option 213, enabling the electronic device to receive an instruction of triggering the game cash flow option 213 and then to switch the content screen 22 to a game cash flow content so that the user can start trading of game points, such as purchase or transfer. The user can also trigger the personal setup option 214, enabling the electronic device to receive an instruction of triggering the personal setup option 214 and then to switch the content screen 22 to the personal setup option 214 so that the user can understand and update the user data. The user can also trigger the instant dynamic option 215, enabling the electronic device to receive an instruction of triggering the instant dynamic option 215 and then to switch the content screen 22 to the instant dynamic content so that the user can get instant messages from the instant dynamic screen. In the game cash flow content, personal setup content or instant dynamic content, the auxiliary display area 222 keeps displaying and tracing the game status.

Thus, either getting in or out of the game screen, the user can be aware of the current game status and process from the auxiliary display area. In the present preferred embodiment, the configuration that the auxiliary display area displays the progress of the current game status is not a combination of texts. In actual application, the progress of the current game status can be indicated by a combination of patterns, voices, or other texts. What are illustrated are not intended to limit the scope of the invention. Further, the allocations of all games can be variously embodied without departing from the spirit of the invention.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An instant messaging and gaming method for use in an electronic device, comprising the steps of:
displaying on an interface a menu bar and a content screen, said menu bar comprising an instant messaging option and a game option;
receiving an instruction of triggering said game option for enabling said content screen to provide a game content and a game status; and
receiving an instruction of triggering said instant messaging option for enabling said content screen to provide an instant messaging content and said game status.

2. The instant messaging and gaming method as claimed in claim 1, wherein said content screen comprises a main display area and an auxiliary display area; said game content and said instant messaging content are respectively displayed on said main display area; said game status is displayed on said auxiliary display area.

3. The instant messaging and gaming method as claimed in claim 1, wherein said menu bar further comprises a game cash flow option; the instant messaging and gaming method further comprises a step of receiving an instruction of triggering said game cash flow option for enabling said content screen to provide a game cash flow content and said game status.

4. An instant messaging and gaming system, comprising:
a plurality of game servers respectively providing a game;
at least one instant messaging server;
a master server linked with said game server and said at least one instant messaging server; and
at least one electronic device adapted for running a program to link to said master server and to display an interface comprising a menu bar and a content screen, said menu bar comprising an instant messaging option and a game option so configured that when said game option is triggered, said content screen provides a game content and a game status; when said instant messaging option is triggered, said content screen provides an instant messaging content and said game status.

5. The instant messaging and gaming system as claimed in claim 4, wherein said content screen comprises a main display area and an auxiliary display area; said game content and said instant messaging content are respectively displayed on said main display area; said game status is displayed on said auxiliary display area.

6. The instant messaging and gaming method as claimed in claim 4, wherein said menu bar further comprises a game cash flow option so configured that when said game cash flow option is triggered, said content screen provides a game flow content and said game status.
